(19) United States
(12) Patent Application Publication
(10) Pub. No.: US 2015/0211592 A1
(43) Pub. Date: Jul. 30, 2015

(54) VIBRATION ISOLATION MEMBER

(71) Applicant: LORD Corporation, Cary, NC (US)

(72) Inventors: Scott A. Rawson, Lake City, PA (US); Marshall W. Downing, Erie, PA (US); Mark F. Negro, Erie, PA (US)

(21) Appl. No.: 14/422,525

(22) PCT Filed: Aug. 28, 2013
(86) PCT No.: PCT/US2013/057068

§ 371 Date: Feb. 19, 2015

Related U.S. Application Data
(60) Provisional application No. 61/786,877, filed on Mar. 15, 2013.
(60) Provisional application No. 61/694,018, filed on Aug. 28, 2012.
(60) Provisional application No. 61/694,002, filed on Aug. 28, 2012.

(51) Int. Cl. F16F 1/41; F16F 1/373

(52) U.S. Cl. CPC F16F 1/41; F16F 1/3732

(57) ABSTRACT

A snubbed isolator comprising: an inner member, the inner member (12) having: a lower member (25) including an upper surface (27) and base (32), wherein the base is wider than the upper surface; a stem (24) integral with the lower member, the stem including a top, wherein the top is oppositely positioned from the base; a surface associated with the top of the stem, the surface being capable of bearing load; an outer member (14) positioned outwardly from the inner member, the outer member having a surface that is wider near the base of the lower member and narrower proximate the upper surface of the lower member; an interlock between the inner and outer members; an elastomeric element (16) bonded between the inner and outer members; and at least one snubbing elastomeric element (34) bonded to the inner member and positioned to snub against a mounting structure.

### CROSS-REFERENCE TO RELATED APPLICATIONS

The present application claims priority to U.S. Provisional Patent Application No. 61/786,877 filed on Mar. 15, 2013 by Rawson et al., entitled “VIBRATION ISOLATION MEMBER”, and the present application claims priority to co-pending U.S. Provisional Patent Application No. 61/694,002 filed on Aug. 28, 2012 by Rawson et al., entitled “VIBRATION ISOLATION MEMBER”, and the present application claims priority to co-pending U.S. Provisional Patent Application No. 61/694,018 filed on Aug. 28, 2012 by Rawson et al., entitled “VIBRATION ISOLATION MEMBER”, all of which are incorporated by reference herein as if reproduced in their entirety.

### FIELD OF INVENTION

This invention relates to the field of vibration control using vibration isolation devices having a combination of elastomeric elements and mounting fixtures.

### BACKGROUND

Isolating vibrations often require the use of snubbed isolators and/or a plurality of isolator devices. The problem is that no isolator provides for a means to specifically avoid hard metal-to-metal impact and associated clicking noise during transient events. When a working elastomer is employed, current isolators typically impact the performance of the elastomer. If space is limited, the isolators usually use less elastomeric product, which further increases the impact on the isolator performance.

Additionally, none of the current isolators provide for a high-load capability and a high-isolation performance while maintaining substantially smaller sizes. There is a need for a snubbed isolator that is capable of three-dimensional damping of vibrations for a structure that it is attached to.

### SUMMARY

The invention provides for a snubbed isolator and an isolator assembly to reduce vibrations in a structure.

In one aspect, a snubbed isolator is provided. The snubbed isolator comprises an inner member, an outer member, an interlock, an elastomeric element and at least one snubbing elastomeric element. The inner member having a lower member including an upper surface and a base, wherein the base is wider than the upper surface. The inner member having a stem integral with the lower member, the stem including a top, wherein the top is oppositely positioned from the base. The inner member having a surface associated with the top of the stem, the surface being capable of bearing load. The outer member positioned outwardly from the inner member, the outer member having a surface that is wider near the base of the lower member and narrower proximate the upper surface of the lower member. The interlock being between the inner and outer members. The elastomeric element bonded between the inner and outer members. The snubbing elastomeric element bonded to the inner member and positioned to snub against a mounting structure.

In another aspect, an isolator assembly is provided. The isolator assembly comprises a mounting plate and a snubbed isolator device. The mounting plate has a plate contoured surface. The snubbed isolator device is proximate to and capable of being attached to the mounting plate. The snubbed isolator device includes: an inner member, a first elastomeric element, a second elastomeric element and an outer member. The inner member has a first and second side. The first elastomeric element is bonded to the first side and the second elastomeric element is bonded to the second side. The second elastomeric element has a contoured surface proximate the plate contoured surface. The outer member is bonded to the first elastomeric element opposite from the first side, and wherein the outer member is positioned proximate to and capable of being attached to the mounting plate.

In another aspect, an isolator assembly is provided. The isolator assembly comprises a mounting plate and a snubbed isolator device. The mounting plate has a plate contoured surface. The snubbed isolator device is proximate to and capable of being attached to the mounting plate. The snubbed isolator device includes: an inner member, a first elastomeric element, a second elastomeric element and an outer member. The inner member has a first and second side. The first elastomeric element is proximate to the first side and the second elastomeric element is proximate to the second side. The second elastomeric element has a contoured surface bonded to the plate contoured surface. The outer member is bonded to the first elastomeric element opposite from the first side, and wherein the outer member is proximate to and capable of being attached to the mounting plate.

In another aspect, an isolator assembly is provided. The isolator assembly comprises a mounting plate and a snubbed isolator device. The mounting plate has a plate contoured surface. The snubbed isolator device is proximate to and capable of being attached to the mounting plate. The snubbed isolator device includes: an inner member, a first elastomeric element, a second elastomeric element and an outer member. The inner member has a first and second side. The first elastomeric element is proximate to the first side and the second elastomeric element is bonded to the second side. The second elastomeric element has a contoured surface proximate the plate contoured surface. The outer member is bonded to the first elastomeric element opposite from the first side, and wherein the outer member is proximate to and capable of being attached to the mounting plate.

In another aspect, an isolator assembly is provided. The isolator assembly comprises a mounting plate and a snubbed isolator device. The mounting plate has a plate contoured surface. The snubbed isolator device is proximate to and capable of being attached to the mounting plate. The snubbed isolator device includes: an inner member, a first elastomeric element, a second elastomeric element and an outer member. The inner member has a first and second side. The first elastomeric element is bonded to the first side and the second elastomeric element is proximate to the second side. The second elastomeric element has a contoured surface bonded to the plate contoured surface. The outer member is proximate the first elastomeric element opposite from the first side, and wherein the outer member is proximate to and capable of being attached to the mounting plate.

In another aspect, an isolator assembly is provided. The isolator assembly comprises a common mounting plate and at least two snubbed isolator devices. The common mounting plate has at least two plate contoured surfaces. The snubbed isolator devices are proximate to and capable of being attached to the common mounting plate, wherein each snubbed isolator device includes: an inner member, a first elastomeric element, a second elastomeric element and an outer member. The inner member has a first and second side. The first elastomeric element is bonded to the first side and the second elastomeric element is bonded to the second side. The second elastomeric element has a contoured surface proximate the plate contoured surface. The outer member is bonded to the first elastomeric element opposite from the first side, and wherein the outer member is proximate to and capable of being attached to the common mounting plate.

Numerous objects and advantages of the invention will become apparent as the following detailed description of the preferred embodiments is read in conjunction with the drawings, which illustrate such embodiments.

### BRIEF DESCRIPTION OF THE DRAWINGS

FIG. 1 illustrates a plan view of a snubbed isolator.

FIG. 2 illustrates a section view of a snubbed isolator taken along section 2-2 of FIG. 1.

FIG. 3A illustrates a plan view of an isolator assembly having a snubbed isolator device on a mounting plate.

FIG. 3B illustrates a perspective view of an isolator assembly having a snubbed isolator device on a mounting plate.

FIG. 4 illustrates a perspective view of an isolator assembly having a snubbed isolator device with a threaded stem hole secured to a mounting plate.

FIG. 5 illustrates a plan view of an isolator assembly having at least two snubbed isolator devices on a common mounting plate.

FIG. 6 illustrates a section view of an isolator assembly taken along section 6-6 of FIG. 5.

FIG. 7 illustrates a perspective view of an isolator assembly having at least two snubbed isolator devices on a common mounting plate.

### DETAILED DESCRIPTION

Reference is made in detail to the present embodiments of the invention, examples of which are illustrated in the accompanying drawings.

Generally, the invention provides an isolator having a mating interface between an inner and outer member with an elastomeric element between and having an additional elastomeric element providing snubbing capability to the isolator. The snubbed isolator is able to provide elastomer pre-compression within the bonded isolator, thereby improving the overall fatigue life of the snubbed isolator. The contoured geometry of the snubbed isolator and the interface between the inner member, outer member and elastomeric elements also provides multi-direction stiffness control. An assembly of side-by-side snubbed isolator devices can support an applied moment. This one-piece assembly is easier to install, compared to using individual snubbed isolator devices.

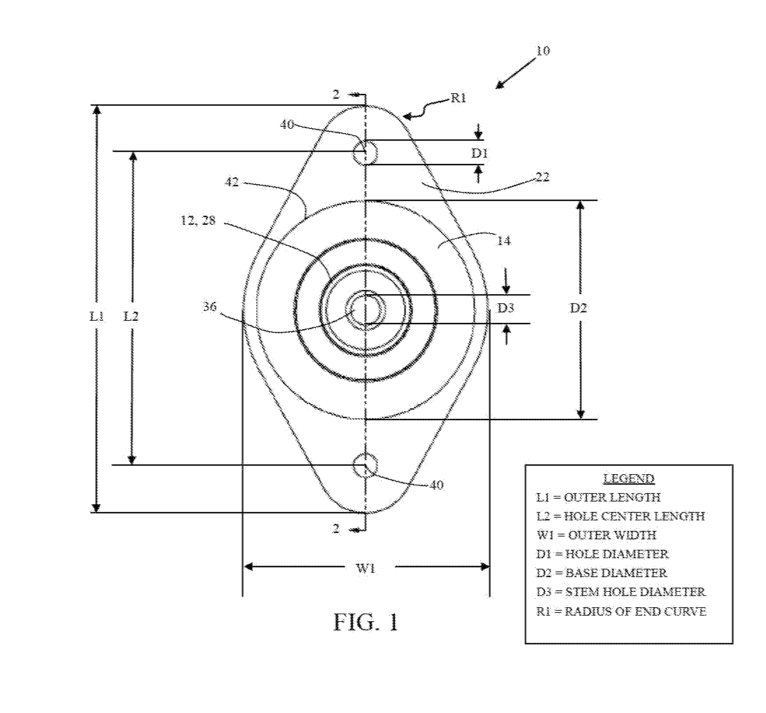

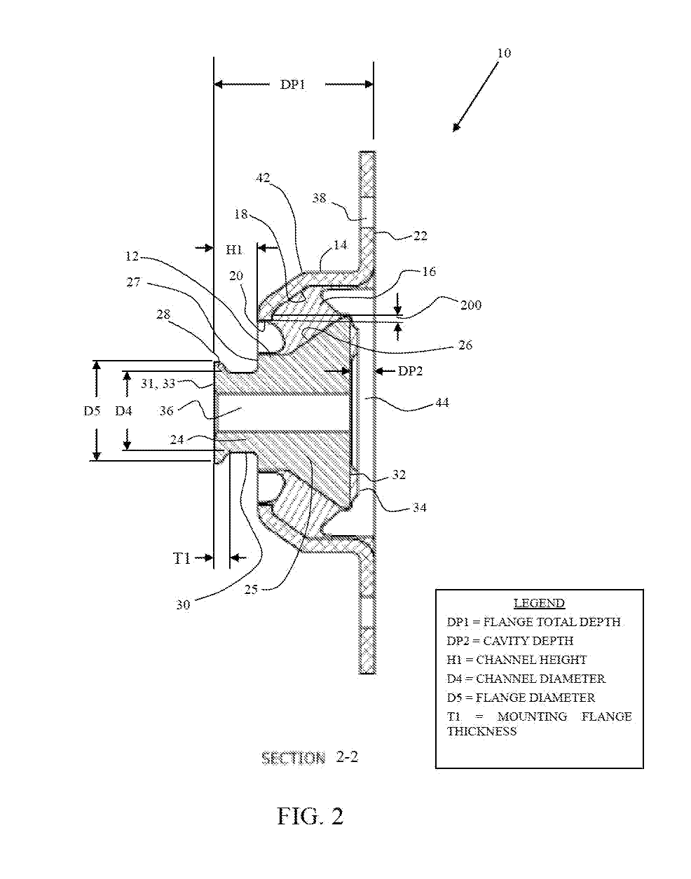

Referring to FIGS. 1 and 2, a snubbed isolator 10 is provided as one embodiment. Snubbed isolator 10 is comprised of inner member 12, outer member 14, and elastomeric element 16. Elastomeric element 16 is bonded between inner member 12 and outer member 14. Outer member 14 includes conical surface 18, exit hole 20 and mounting plate 22, which is also referred to as base flange 22. Inner member 12 includes stem 24 and lower member 25. Stem 24 is integral with lower member 25. Stem 24 includes flange 28 and channel 30. Lower member 25 includes conical surface 26, upper surface 27 and base 32. Base 32 is wider than upper surface 27. Stem 24 is sized according to design need. Flange 28 is positioned on stem 24 and provides for the load-bearing surface of stem 24. Channel 30 is also positioned on stem 24. Base 32 and base elastomer 34 are positioned at the lower end of lower member 25 of inner member 12, with base elastomer 34 affixed to lower member 25 at base 32. Base elastomer 34 is also referred to as snubbing elastomeric element 34.

Snubbed isolator 10 is interlocked by the outer diameter of base 32 of inner member 12 being greater than the diameter of exit hole 20 of outer member 14. This interlocking interference between base 32 and exit hole 20 is interlock 200. Interlock 200 prevents inner member 12 from being pulled out of outer member 14.

As illustrated in FIGS. 1 and 2, the elastomeric snubbing using base elastomer 34 avoids hard (metal-to-metal) contact with any isolator brackets or support structures during high-displacement events (transients, etc.) in the axial direction. In this embodiment base elastomer 34 is referred to as snubbing elastomeric element 34. The elastomeric snubbing feature of base elastomer 34 is not part of the working area of elastomeric element 14, or the “working elastomer”. Snubbed isolator 10 is designed with conical surfaces 18 and 26 on the outer member 14 and inner member 12, respectively, for axial-to-radial stiffness control. However, it is understood that other geometries are possible.

Channel 30 of stem 24 is sized with a diameter D4. D4 is determined by the use of snubbed isolator 10 and is positioned between flange 28 and upper surface 27. Flange 28 carries load on load-bearing surface 31, and it is used for mating components. Diameter D5 in FIG. 2 illustrates a non-limiting example of a diameter associated with load-bearing surface 31. Load-bearing surface 31 is coincident with top 33.

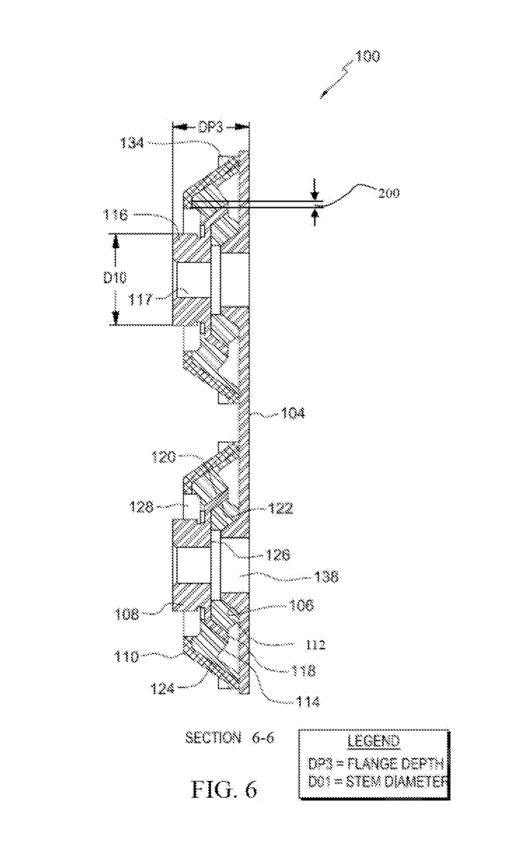

Stem 24 can be modified to incorporate other features or interfaces (keyways, grooves, flanges, helical wire inserts, etc.). In the embodiment illustrated in FIGS. 1 and 2, stem 24 has stem hole 36. Stem hole 36 provides for additional mounting capabilities, such as a non-limiting example of a threaded interior 117 illustrated in FIG. 6 for mounting a screw (not shown) and securing it therethrough. Other mounting device configurations are considered such as bolts and rivets.

Inner member 12 and outer member 14, in the embodiment illustrated in FIGS. 1 and 2, are preferably fabricated out of stainless steel and aluminum, respectively, although other combinations, including thermoplastics and composites, will work depending upon the particular application.

Referring to snubbed isolator 10 illustrated in FIG. 1, outer length L1 defines a first dimension of mounting plate 22 and outer width W1 defines a second dimension of mounting plate 22. Mounting holes 38 are disposed through mounting plate 22 and have a hole diameter of D1. Hole diameter D1 is defined by the mounting requirements of the mounting device (not shown) and devices used to mount snubbed isolator 10 to a structure. Preferably, snubbed isolator 10 has at least two mounting holes 38 disposed through mounting plate 22. As illustrated, mounting holes 38 have a center 40 and the distance between center 40 of mounting holes 38 is hole center length L2. D2 illustrates the diameter of the beginning of the outer conical surface 42 of outer member 14. Stem 24 also has a hole disposed therethrough and D3 illustrates the inner diameter of stem hole 36.

Table 1 indicates that D3 is sufficiently sized to accept a #10-32 threaded bolt or other mounting device. It is known to those having skill in the art that any mounting device can be made to be compatible with D3.

Referring to snubbed isolator 10 illustrated in FIG. 2, total flange depth DP1 defines the overall height or depth of snubbed isolator 10. The diameter of channel 30 is illustrated by D4 and the diameter of mounting flange 28 is illustrated by D5. The height of channel 30 is illustrated by H1. If used, mounting flange thickness T1 is defined by the particular load-bearing requirement.

As illustrated, snubbed isolator 10 has cavity 44 positioned below inner member 12. Cavity 44 has a cavity depth of DP2. Base elastomer 34, or snubbing elastomeric element 34, of inner member 12 extends into a portion of cavity 44.

Mounting plate 22 of snubbed isolator 10 is illustrated as having curved ends with the radius of end curve being R1.

Table 1 below refers to the embodiment illustrated in FIGS. 1 and 2, wherein a non-limiting representative of snubbed isolator 10 has the following values:

TABLE 1

| | Representative Value |
|---|---|
| Reference | (measurement = about) |
| L1 = Outer length | 2.220 inches |
| L2 = Hole center length | 1.700 inches |
| W1 = Outer width | 1.330 inches |
| D1 = Hole diameter | 0.131 inches |
| D2 = Base diameter | 1.200 inches |
| D3 = Stem hole diameter | sufficient to accept a |
| | #10-32 threaded bolt or |
| | mounting device |
| D4 = Channel diameter | 0.340 inches |
| D5 = Flange diameter | 0.435 inches |
| R1 = Radius of end curve | 0.260 inches |
| DP1 = Flange total depth | 0.685 inches |
| DP2 = Cavity depth | 0.075 inches |
| H1 = Channel height | 0.220 inches |
| T1 = Mounting flange | 0.020-0.050 inches |
| thickness | |

In use, the snubbing feature of snubbed isolator 10 eliminates “clicking” noises due to metal-to-metal contact. It also reduces wear on the contacting metal components. Snubbing, in general, limits deflection for protection of the isolator “working elastomer”. The snubbing feature is particularly useful when a soft isolator is desired, with limited envelope available for clearance. A large load-bearing area on the inner member stem distributes clamping and application forces, while reducing stress on mating components. This is particularly useful with the use of advance composite materials.

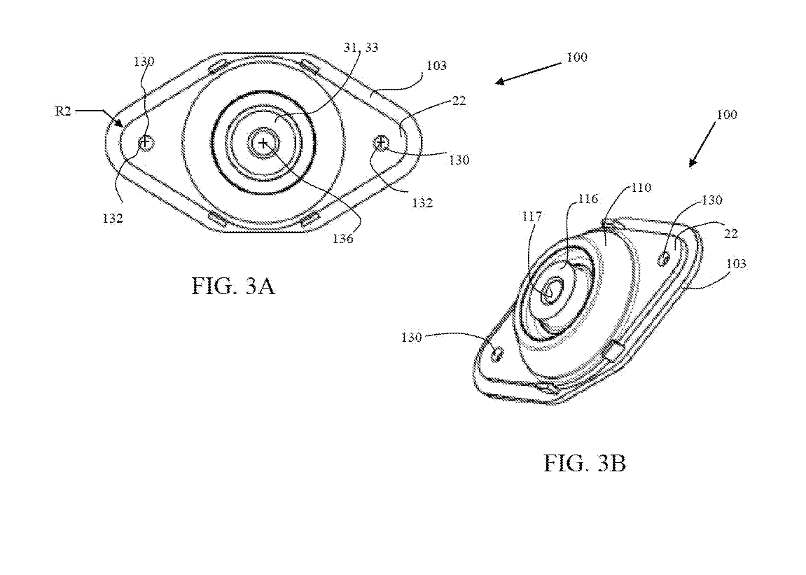

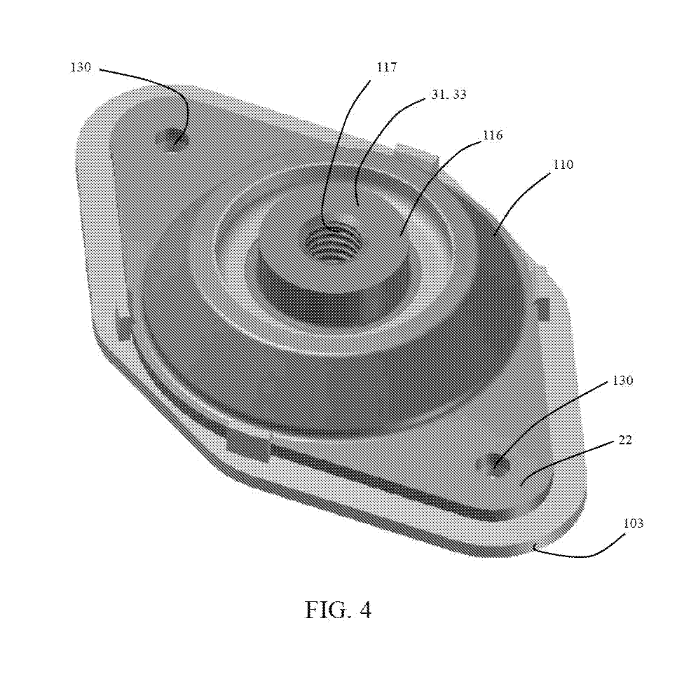

Referring to FIGS. 3A-4, an isolator assembly 100 embodiment is provided using a snubbed isolator device 102 proximate to and capable of being attached to mounting plate 103, also known as single base flange 103. Mounting plate 103 has plate contoured surface 106. FIGS. 3A-4, illustrate a single isolator assembly with a single snubbed isolator device 102 on a single mounting plate 103. Unless otherwise indicated, snubbed isolator device 102 use the same reference character numbers as identified above for snubbed isolator 10.

Snubbed isolator device 102 is comprised of inner member 108, outer member 110, inner elastomeric element 112 and outer elastomeric element 114. Elastomeric elements 112 and 114 are pre-compressed. In one embodiment, elastomeric element 114 is bonded between inner member 108 and outer member 110.

Inner member 108 includes stem 116 and conical member 118. Stem 116 is sized according to design need. Stem 116 is sized to provide a load-bearing capacity based upon a particular design need of the end use. As illustrated, stem 116 has stem hole 117. Stem hole 117 provides for mounting capabilities, such as a non-limiting example of a screw (not shown) being secured therethrough. Other mounting device configurations are considered such as bolts and rivets. Conical member 118 of inner member 108 includes first side 120 and second side 122. Elastomer elements 114 and 112 are bonded on both first side 120 and second side 122, respectively, of inner member 108.

Outer member 110 includes conical member 124. In the embodiment above, conical member 124 of outer member 110 is bonded to elastomeric element 114, which is also bonded to first side 120 of conical member 118. Outer member 110 is in contact with mounting plate 103. Elastomeric element 112 is bonded to second side 122 of conical member 118 and is in contact with plate contoured surface 106 of mounting plate 103.

Snubbed isolator devices 102 of isolator assembly 100 are interlocked by the outer diameter of base 126 of inner member 108 being greater than the diameter of exit hole 128 of outer member 110. Interlock 200, as represented in FIG. 6 for a dual system, prevents inner member 108 from being pulled out of outer member 110.

One elastomer section 114 is positioned to mechanically react against outer member 110 and other elastomer section 112 is positioned to mechanically react against mounting plate 103 at contoured surface 106. In this embodiment, elastomer 112 is not bonded to mounting plate 103.

Mounting plate 103 and adjacent elastomer member 112 have a contoured interface for multi-direction load capability. The contoured interface is where contoured surface 106 and elastomer member 112 are proximate to each other. Contoured surface 106 of mounting plate 103 is capable of reacting load in multiple directions.

Mounting plate 103 material is ideally thermoplastic or a composite to reduce both the per-unit cost and weight. However, mounting plate 103 material may also be metal.

When installed, the snubbed isolator device 102 pull out load (axial tension) is supported by inner member 108 and outer member 110. As illustrated, mounting plate 103 is not in a load path.

The embodiment illustrated in FIGS. 3A-4 is assembled using integral snap-in features, although other methods (rivets, adhesive, etc.) will also work. The snubbed isolator device 102 and common mounting plate 102, may also be left unassembled until installation.

Other embodiments of isolator assembly 100 include snubbed isolator device 102 which is comprised of inner member 108, outer member 110, inner elastomeric element 112 and outer elastomeric element 114. Elastomeric elements 112 and 114 are pre-compressed. In one embodiment, elastomeric element 114 is bonded between inner member 108 and outer member 110 and elastomeric element 112 is only bonded to inner member 108. In another embodiment, elastomeric element 114 is bonded to outer member 110 and elastomeric element 112 is bonded to inner member 108. In another embodiment, elastomeric element 114 is bonded to outer member 110 and elastomeric element 112 is bonded to contoured surface 106 of mounting plate 103. In another embodiment, elastomeric element 114 is bonded to inner member 108 and elastomeric element 112 is bonded to contoured surface 106 of mounting plate 103. Other combinations available but not addressed for the sake of brevity.

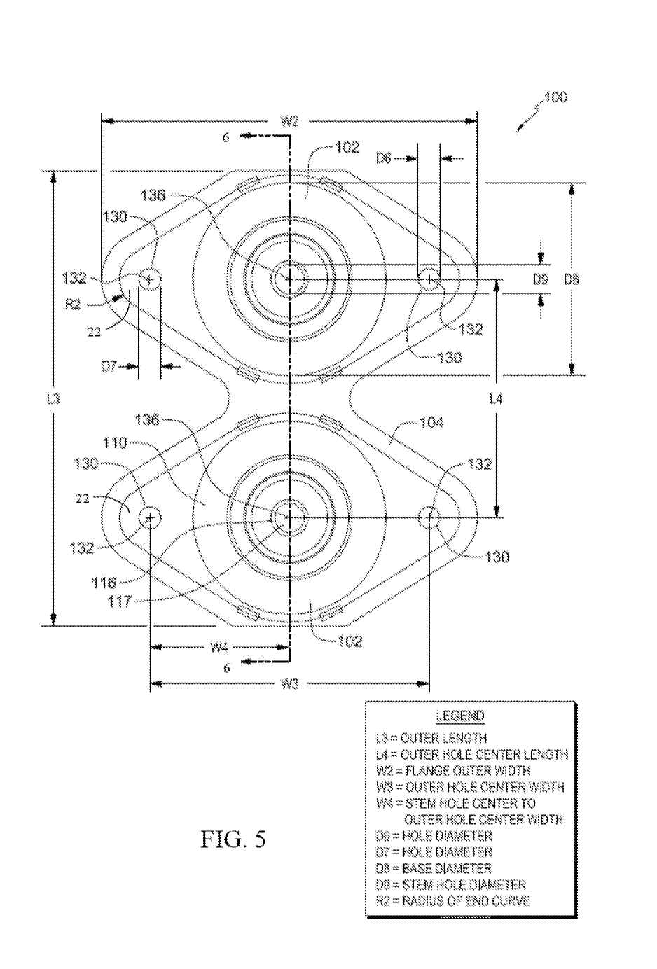

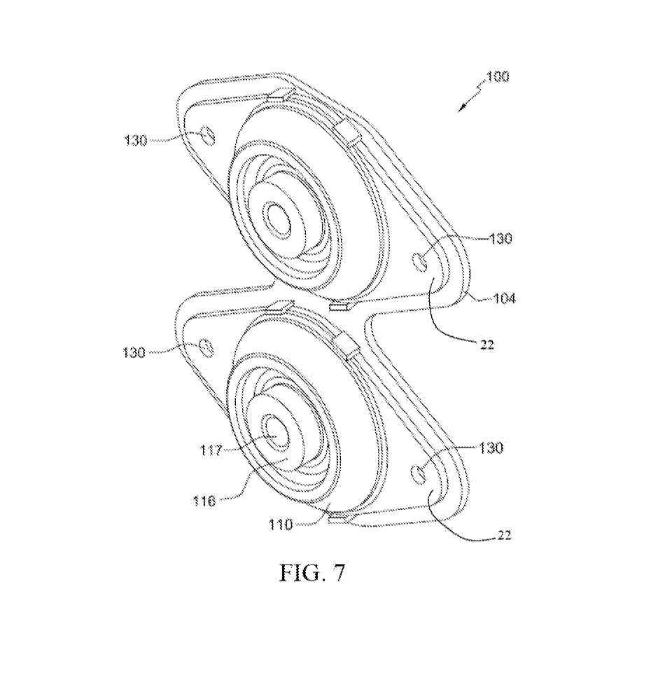

Referring to FIGS. 5-7, another alternative isolator assembly 100 embodiment is provided using at least two snubbed isolator devices 102 proximate to and capable of being attached to a single, common mounting plate 104, also known as base flange 104. Common mounting plate 104 has at least two plate contoured surfaces 106. The number of snubbed isolator devices 102 is not limited to two on a single common mounting plate 104. Unless otherwise indicated, snubbed isolator devices 102 use the same reference character numbers as identified above for snubbed isolator 10.

Each snubbed isolator device 102 is comprised of inner member 108, outer member 110, inner elastomeric element 112 and outer elastomeric element 114. Elastomeric elements 112 and 114 are pre-compressed. Elastomeric element 114 is bonded between inner member 108 and outer member 110.

Inner member 108 includes stem 116 and conical member 118. Stem 116 is sized according to design need. Stem 116 is sized to provide a load-bearing capacity based upon a particular design need of the end use. As illustrated, stem 116 has stem hole 117. Stem hole 117 provides for mounting capabilities, such as a non-limiting example of a screw (not shown) being secured therethrough. Other mounting device configurations are considered such as bolts and rivets. Conical member 118 of inner member 108 includes first side 120 and second side 122. Elastomer elements 114 and 112 are bonded on both first side 120 and second side 122, respectively, of inner member 108.

Outer member 110 includes conical member 124. Conical member 124 of outer member 110 is bonded to elastomeric element 114, which is also bonded to first side 120 of conical member 118. Outer member 110 is in contact with common mounting plate 104. Elastomeric element 112 is bonded to second side 122 of conical member 118 and is in contact with contoured surface 106 of common mounting plate 104.

Snubbed isolator devices 102 of isolator assembly 100 are interlocked by the outer diameter of base 126 of inner member 108 being greater than the diameter of exit hole 128 of outer member 110. Interlock 200 prevents inner member 108 from being pulled out of outer member 110.

One elastomer section 114 is positioned to mechanically react against outer member 110 and other elastomer section 112 is positioned to mechanically react against common mounting plate 104 at contoured surface 106. In this embodiment, elastomer 112 is not bonded to common mounting plate 104.

Common mounting plate 104 and adjacent elastomer member 112 have a contoured interface for multi-direction load capability. The contoured interface is where contoured surface 106 and elastomer member 112 are proximate to each other. Contoured surface 106 of common mounting plate 104 are capable of reacting load in multiple directions.

Common mounting plate 104 material is ideally thermoplastic or a composite to reduce both the per-unit cost and weight. However, common mounting plate 104 material may also be metal.

When installed, the snubbed isolator device 102 pull out load (axial tension) is supported by inner member 108 and outer member 110. As illustrated, common mounting plate 104 is not in a load path. With respect to the pull out load for the embodiment where elastomeric element 112 is not bonded to contoured surface 106, inner member 108, elastomeric element 114, and outer member 110 define the load path of snubbed isolator device 102, where inner member 108 provides a load to elastomeric element 114 which in turn provides a load to outer member 110.

The embodiment illustrated in FIGS. 5-7 is assembled using integral snap-in features, although other methods (rivets, adhesive, etc.) will also work. The three components, the two snubbed isolator devices and common mounting plate 104, may also be left unassembled until installation.

Referring to snubbed isolator assembly 100 illustrated in FIG. 5, outer length L3 defines a first dimension of common mounting plate 104 and outer width W2 defines a second dimension of common mounting plate 104. Mounting holes 130 are disposed through common mounting plate 104 and have a hole diameters of D6 and hole diameter of D7. Hole diameters D6 and D7 are the same. Mounting hole 130 is illustrated in FIG. 5 with each hole diameter thereon. Similar to the embodiment in FIGS. 1 and 2, hole diameters D6 and D7 are defined by the mounting requirements of the mounting device (not shown) and devices used to mount isolator assembly 100 to a structure. Preferably, isolator assembly 100 has at least four mounting holes 130 disposed through common mounting plate 104 and outer members 110. As illustrated, mounting holes 130 have a center 132 and the distance between center 132 of mounting holes 130 in a first direction is outer hole center length L4, and in a second direction is outer hole center width W3. As illustrated outer hole center length L4 is measured between separate snubbed isolator devices 102, and outer hole center width W3 is measured across a single snubbed isolator device 102.

D8 illustrates the diameter of the beginning of the outer conical surface 134 of outer member 110. Stem hole 117 is a hole disposed through stem 116. D9 illustrates the inner diameter of stem hole 117. Stem hole center 136 is the center of the hole in stem 116 when viewed from the plan view. The distance between stem hole center 136 and an outer hole center of mounting hole 130 is W4.

Referring to isolator assembly 100 illustrated in FIG. 6, flange depth DP3 defines the overall height or depth of isolator assembly 100. Stem 116 is illustrated having a diameter of D10.

As illustrated, isolator assembly 100 has cavity 138 positioned below stem 116. Stem 116, stem hole 117 and cavity 138, in combination, provides for a point to secure devices to isolator assembly 100. Note, any securing device used with isolator assembly 100 does not have to extend into cavity 138.

Common mounting plate 104 of isolator assembly 100 is illustrated as having curved ends for each snubbed isolator device 102. These curved ends align with the radius R2 of the curve of mounting plate 22 of snubbed isolator device 102.

Table 2 below refers to the embodiment illustrated in FIGS. 3A-7, wherein a non-limiting representative of isolator assembly 100 has the following values:

TABLE 2

| | Representative Value |
|---|---|
| Reference | (measurement = about) |
| L3 = Outer length | 2.640 inches |
| L4 = Hole center length | 1.380 inches |
| W2 = Outer width | 2.210 inches |
| W3 = Hole center length | 1.620 inches |
| W4 = Hole center length | 0.810 inches |
| D6 = Mounting hole diameter | 0.103 inches |
| D7 = Mounting hole diameter | 0.103 inches |
| D8 = Base diameter | 1.122 |
| D10 = Stem diameter | 0.445 inches |
| DP3 = Overall mounting | 0.375 inches |
| height | |
| R2 = Radius of end curve | 0.180 inches |

The use of common mounting plate 104 provides for isolator assembly 100 as a one-piece device to improve the ease of installation. Opposing elastomer sections 112 and 114 on each side of the conical member 118 of inner member 108 provide for snubbing in all directions, while maintaining vibration isolation. In this configuration, one side is always in a compressive state. Pre-compressing the elastomer significantly reduces fatigue of the elastomer associated with long-term use and greatly increases the life of the isolator assembly. The interface between un-bonded elastomeric element 112 and contoured surface 106 of common mounting plate 104 provides for an increase of the axial compression and radial load capability of isolator assembly 100. The contoured interface provides both axial and radial load capability with axial-to-radial stiffness control

Other embodiments of the current invention will be apparent to those skilled in the art from a consideration of this specification or practice of the invention disclosed herein. Thus, the present invention is well adapted to carry out the objects and attain the ends and advantages mentioned as well as those inherent therein. While preferred embodiments of the present invention have been illustrated for the purpose of the present disclosure, changes in the arrangement and construction of parts and the performance of steps can be made by those skilled in the art, which changes are encompassed within the scope and spirit of the present invention as defined by the appended claims.

What is claimed is:

1. A snubbed isolator comprising:
an inner member, the inner member having:
a lower member including an upper surface and base, wherein the base is wider than the upper surface;
a stem integral with the lower member, the stem including a top, wherein the top is oppositely positioned from the base;
a surface associated with the top of the stem, the surface being capable of bearing load;
an outer member positioned outwardly from the inner member, the outer member having a surface that is wider near the base of the lower member and narrower proximate the upper surface of the lower member;
an interlock between the inner and outer members;
an elastomeric element bonded between the inner and outer members; and
at least one snubbing elastomeric element bonded to the inner member and positioned to snub against a mounting structure.

2. The snubbed isolator of claim 1, wherein the top is a flange, the flange being integral with the stem and having a diameter greater than the stem.

3. The snubbed isolator of claim 1, wherein the stem further comprises a stem hole, the stem hole having a mounting surface thereon.

4. The snubbed isolator of claim 3, wherein the mounting surface is threaded.

5. The snubbed isolator of claim 3, wherein the top is a flange, the flange being secured to the mounting surface.

6. An isolator assembly comprising:
a mounting plate having a plate contoured surface;
a snubbed isolator device proximate to and capable of being attached to the mounting plate, the snubbed isolator device including:
an inner member having a first and second side;
a first elastomeric element bonded to the first side;
a second elastomeric element bonded to the second side, the second elastomeric element has a contoured surface proximate the plate contoured surface;
an outer member bonded to the first elastomeric element opposite from the first side; and
wherein the outer member is proximate to and capable of being attached to the mounting plate.

7. The isolator assembly of claim 6, wherein the mounting plate is further comprised of a material selected from the group comprising thermoplastics, composites, and metals.

8. The isolator assembly of claim 6, wherein the contoured surface of the mounting plate and the contoured surface of the elastomeric element bonded to the second side are capable of carrying load in multiple directions.

9. An isolator assembly comprising:
a mounting plate having a contoured surface;
a snubbed isolator device proximate to and capable of being attached to the mounting plate, the snubbed isolator device including:
an inner member having a first and second side;
a first elastomeric element proximate to the first side;
a second elastomeric element proximate to the second side, the second elastomeric element has a contoured surface bonded to the plate contoured surface;
an outer member bonded to the first elastomeric element opposite from the first side; and
wherein the outer member is proximate to and capable of being attached to the mounting plate.

10. The isolator assembly of claim 9, wherein the mounting plate is further comprised of a material selected from the group comprising thermoplastics, composites, and metals.

11. The isolator assembly of claim 9 wherein the elastomeric element bonded to the contoured surface of the mounting plate and proximate to the second side of the inner member are capable of carrying load in multiple directions.

12. An isolator assembly comprising:
a mounting plate having a contoured surface;
a snubbed isolator device proximate to and capable of being attached to the mounting plate, the snubbed isolator device including:
an inner member having a first and second side;
a first elastomeric element proximate to the first side;
a second elastomeric element bonded to the second side, the second elastomeric element has a contoured surface proximate to the plate contoured surface;
an outer member bonded to the first elastomeric element opposite from the first side; and
wherein the outer member is proximate to and capable of being attached to the mounting plate.

13. The isolator assembly of claim 12, wherein the mounting plate is further comprised of a material selected from the group comprising thermoplastics, composites, and metals.

14. The isolator assembly of claim 12, wherein the contoured surface of the mounting plate and the contoured surface of the elastomeric element bonded to the second side are capable of carrying load in multiple directions.

15. An isolator assembly comprising:
a mounting plate having a contoured surface;
a snubbed isolator device proximate to and capable of being attached to the mounting plate, the snubbed isolator device including:
an inner member having a first and second side;
a first elastomeric element bonded to the first side;
a second elastomeric element proximate to the second side, the second elastomeric element has a contoured surface bonded to the plate contoured surface;
an outer member proximate to the first elastomeric element opposite from the first side; and
wherein the outer member is proximate to and capable of being attached to the mounting plate.

16. The isolator assembly of claim 15, wherein the mounting plate is further comprised of a material selected from the group comprising thermoplastics, composites, and metals.

17. The isolator assembly of claim 15, wherein the elastomeric element bonded to the contoured surface of the mounting plate and proximate to the second side of the inner member are capable of carrying load in multiple directions.

18. An isolator assembly comprising:
a common mounting plate having at least two plate contoured surfaces;
at least two snubbed isolator devices proximate to and capable of being attached to the common mounting plate, wherein each snubbed isolator device includes:
an inner member having a first and second side;
a first elastomeric element bonded to the first side;
a second elastomeric element bonded to the second side, the second elastomeric element has a contoured surface proximate the plate contoured surface;
an outer member bonded to the first elastomeric element opposite from the first side; and
wherein the outer member is proximate to and capable of being attached to the common mounting plate.

19. The isolator assembly of claim 18, wherein the common mounting plate is further comprised of a material selected from the group comprising thermoplastics, composites, and metals.

20. The isolator assembly of claim 18, wherein each of the contoured surfaces of the mounting plate and each of the contoured surface of the elastomeric element bonded to the second side proximate thereto are capable of carrying load in multiple directions.
